(19) United States
(12) Patent Application Publication
(10) Pub. No.: US 2011/0085041 A1
(43) Pub. Date: Apr. 14, 2011

(54) STABLY ALIGNED PORTABLE IMAGE CAPTURE AND PROJECTION

(76) Inventor: Michael Rogler Kildevaeld, Yarmouthport, MA (US)

(21) Appl. No.: 12/897,739

(22) Filed: Oct. 4, 2010

Related U.S. Application Data
(60) Provisional application No. 61/248,476, filed on Oct. 4, 2009.
(60) Provisional application No. 61/298,730, filed on Jan. 27, 2010.

(51) Int. Cl. H04N 7/18

(52) U.S. Cl. 348/158; 348/159; 348/E07.085

(57) ABSTRACT

A system for streaming digital media over a network includes a plurality of cameras configured with an image capture facility to capture images; an image stabilization and alignment facility disposed within at least one of the plurality of cameras; and a data transmission channel adapted to transmit the digital media including the captured images to a network-enabled handheld device for storage and manipulation. The system can be integrated with a projector to perform as a camera and projector device for sharing and/or projecting media.

### CROSS-REFERENCE TO RELATED APPLICATIONS

This application claims the benefit of the following provisional applications, each of which is hereby incorporated by reference in its entirety:

U.S. Ser. No. 61/248,476 filed Oct. 4, 2009; and U.S. Ser. No. 61/298,730 filed Jan. 27, 2010.

### BACKGROUND OF THE INVENTION

1. Field

The present invention relates to alignment of imaging devices for stable capture and projection of images.

2. Description of the Related Art

Portable, handheld, and miniaturized cameras and personal projectors facilitate the capture and presentation of live or stored images and videos in a wide variety of applications, including moving applications. Image quality is at least partially dependent on how the camera and/or projector is supported; mounting such an imaging device to an object that can change orientation suddenly (e.g. a snowboarder's helmet or a remote control aerial device) may result in a compromised image quality. With ubiquity of such imaging devices now and in the near future features that facilitate improved image quality may significantly improve the useability of such digital imaging cameras and projectors.

### SUMMARY OF THE INVENTION

In embodiments of the present invention, improved capabilities are described for a system and method for staby capturing and providing live media (e.g. audio, video, and the like) for projection and/or over a wireless network. The system may include a plurality of media capture and/or projection facilities configured to facilitate capture and presentation of live video, audio, and other types of media. The system may further include a handheld device configured to store and manipulate the live media. A data transmission channel adapted to transmit the live media from the plurality of camera to the handheld device may be employed.

In embodiments, the method of streaming the live media over the network may include capturing the live media through a camera-based system, transferring it to a handheld device, manipulating it on the handheld device, and finally streaming to the network. The network may be an online portal.

The system may alternatively include a projector to perform as a camera projector device. The camera projector device may be utilized to capture, share and project media. In any implementation, image stabilization and alignment may be provided through an inventive stabilization feature, such as one based on a gimbal or gyroscope facility.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a portable device for streaming media over a network, in accordance with an embodiment of the present invention;

FIG. 2A depicts a portable device including a plurality of cameras, in accordance with another embodiment of the present invention;

FIG. 2B depicts perspective views of a portable device configured as a wireless docking station, in accordance with various embodiments of the present invention;

FIG. 3 depicts a portable device for streaming media over a network, in accordance with still another embodiment of the present invention;

FIG. 4A and FIG. 4B illustrate perspective views of a gimbal balance system, in accordance with an embodiment of the present invention;

FIG. 4C illustrates a cross-sectional view of the gimbal balance system assembled in the design of the camera, in accordance with the embodiment illustrated in conjunction with FIG. 4A and FIG. 4B of the present invention;

FIG. 5 depicts a networked system including the portable device connected with a handheld device, in accordance with the embodiments illustrated in conjunction with FIG. 1, FIG. 2, and FIG. 3;

FIG. 6 illustrates perspective views of physical design of the camera included in a portable device, in accordance with various embodiments of the present invention;

FIG. 7A, FIG. 7B and FIG. 7C illustrate various cross-sectional views of physical design of a (Camera Projector Device) CPD included in a portable device, in accordance with various embodiments of the present invention;

FIG. 8A illustrates a perspective view of a mounting device for mounting the CPD on a helmet, in accordance with an embodiment of the present invention;

FIG. 8B illustrates a perspective view of the CPD with the mounting device mounted thereon, in accordance with an embodiment of the present invention;

FIGS. 9A and 9B illustrate perspective views of the CPD along with a charging unit;

FIG. 10 illustrates a perspective view of a wall mount to mount the CPD on a wall, in accordance with an embodiment of the present invention;

FIG. 11A and FIG. 11B illustrate perspective views of a desk mount to mount the CPD on a desk or table or shelf and the like, in accordance with an embodiment of the present invention;

FIG. 12A, FIG. 12B and FIG. 12C illustrate various perspective views of the CPD integrated with a mounting of a clip, in accordance with an embodiment of the present invention;

FIG. 13A, FIG. 13B, FIG. 13C and FIG. 13D illustrate perspective views of a motion detector for use with the CPD, in accordance with various embodiments of the present invention;

FIG. 14A, FIG. 14B, FIG. 14C, and FIG. 14D illustrate perspective views of the CPD configured to be fitted in a door, in accordance with an embodiment of the present invention;

FIG. 15A, and FIG. 15B illustrate perspective views of the CPD configured as a windshield mount to be used in vehicles, in accordance with an embodiment of the present invention;

FIG. 16 illustrates a projection functionality of the CPD acting as a projector, in accordance with an embodiment of the present invention;

FIG. 17 illustrates a handheld remote controller for the CPD, in accordance with an embodiment of the present invention; and

FIG. 18 illustrates a handheld remote controller for the CPD, in accordance with another embodiment of the present invention.

### DETAILED DESCRIPTION OF THE PREFERRED EMBODIMENT(S)

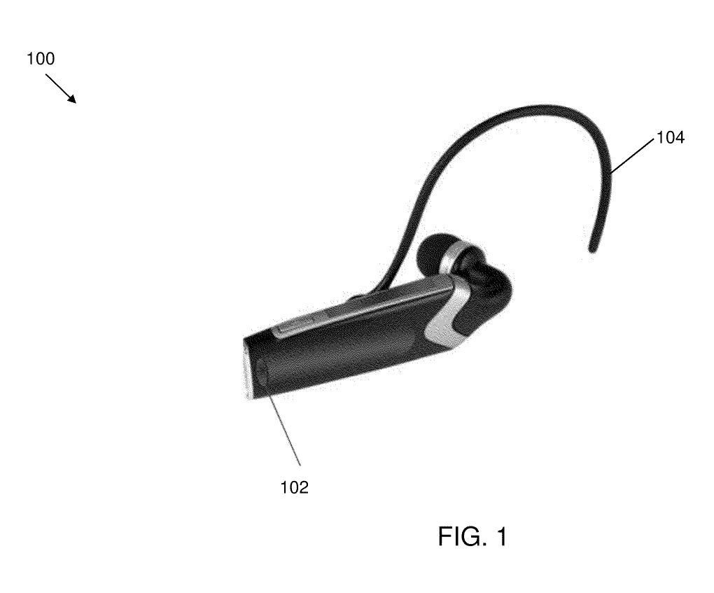

FIG. 1 depicts a portable device 100 for streaming media over a network, in accordance with an embodiment of the present invention. The portable device 100 may include a camera 102 and a headset 104, to which the camera 102 may be connected fixedly or in a detachable manner. In embodiments, the headset 104 may be a Bluetooth headset 104 having the camera 102 built into it to capture video, audio, or both. In an exemplary scenario, the headset 104 may be an earphone or headphone, or a set of earphones or headphones. The set of earphones or headphones may be audio earphones or headphones. The portable device 100, in accordance with this embodiment, when used with Bluetooth may be termed as a Bluetooth camera headset.

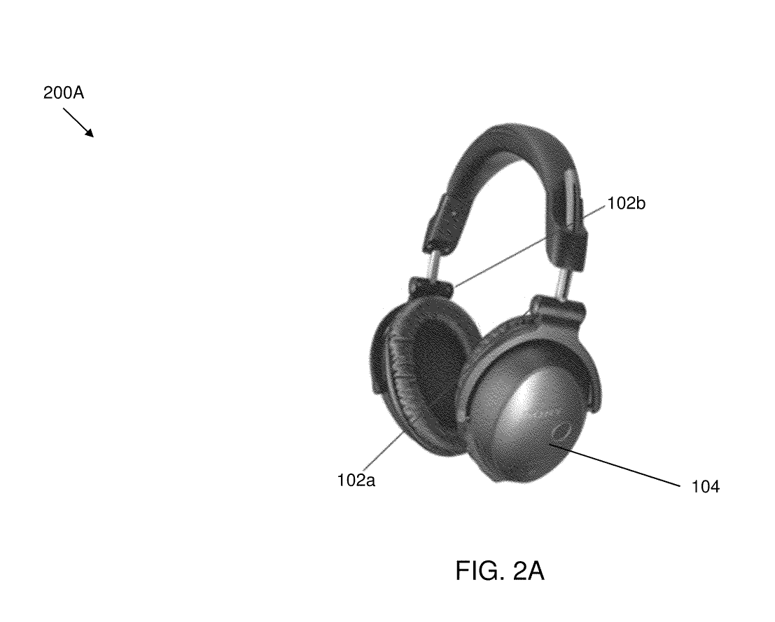

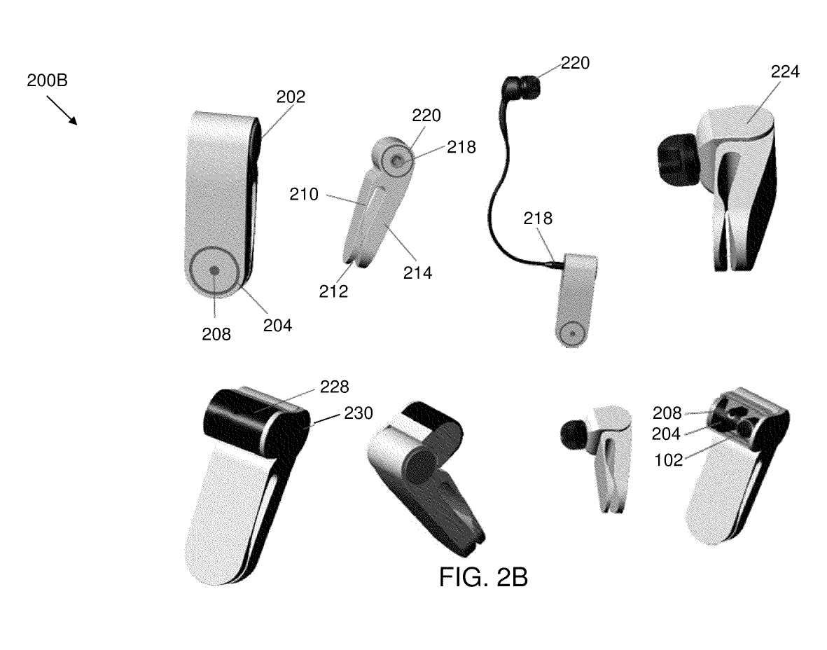

FIG. 2A depicts a portable device 200A including a plurality of cameras such as a camera 102a and 102b, in accordance with another embodiment of the present invention. The portable device 200A may further include a headset 104 to which the camera 102a and 102b may be connected in a fixed or detachable manner. In embodiments, the headset 104 may be a Bluetooth headset having the camera 102a and 102b in-built to capture video, audio or both.

In accordance with this embodiment, one of the two cameras such as the camera 102a may be fitted to point in the forward direction while the other camera such as the camera 102b may be fitted to point in the backward direction. The cameras 102a and 102b may provide a user a forward and a backward vision, respectively.

In accordance with alternative contexts, the cameras 102a and 102b may be interchanged based on user preferences such that the camera 102a may point behind the user while the camera 102b may point forward. The portable device 200A may also act as a spy instrument with a spy camera in accordance with this embodiment. For example, the user may record activities in front of him while still keeping a watch and recording the activities behind him. In an alternative design, the portable device 200A may be embodied in the form of the small camera 102a without providing it a look like headset 104 to enhance spy activities.

FIG. 2B depicts perspective views of a portable device configured as a wireless docking station 200B, in accordance with various embodiments of the present invention. The docking station 200B may perform as a wireless or wired microphone or a speaker system or both, in accordance with various embodiments, some of which are illustrated in FIG. 2B. The docking station 200B may include a power button 202, a speaker 204, a microphone 208, a built-in or separately added clip 210, an opening of the clip 212, a body portion 214 for housing electronics circuitry, an ear jack 218, a second docking port 220 for video if required to add extra functionality, a short ear bud 222, an ear piece 224, a speaker and microphone housing 228, a second jack 230, and a camera 102. The microphone 208 may be hooked to any wireless device such as a Bluetooth enabled device that may facilitate capturing, recording and transferring of media from one location to another. The activity of capturing, recording and transferring of the media may be possible from remote places (e.g., above 20 feet) or from very large distances.

The ear jack 218 may be a conventional ear jack, in accordance with an exemplary embodiment of the present invention. The ear jack 218 may be secured with attachments such as a charger to charge the docking station 200B. Additionally, data or media transfer attachments may also be secured to the ear jack 218.

The short ear bud 222 that may be a single ear bud or a stereo may be utilized to allow a user to clip the docking station 200B to a cap, shirt collar, and similar other accessories and apparels. The short ear bud 222 may include a short and light cable that may be comfortably attached to the ear. The cable may be pulled out of the ear easily whenever desired.

The ear piece 224 may be a solid element that may be mounted into the ear jack 218 to convert it into a Bluetooth system with a capability of making phone calls.

The speaker and microphone housing 228 may facilitate external add-on features by adding the speaker 204 and the microphone 208 with better customized requirements such as for a spy camera. However, the preferred use of the docking station 200B is to make phone calls and show live video activities to remote locations while the user is busy in certain tasks (hands free mode).

The second jack 230 may hold the housing in place and also perform tasks such as data and media transfer with the help of such as a USB or an HDMI connection. The second jack 230 may also assist in custom designed docking. The portable device 200A and 200B may together be referred to as the portable device 200.

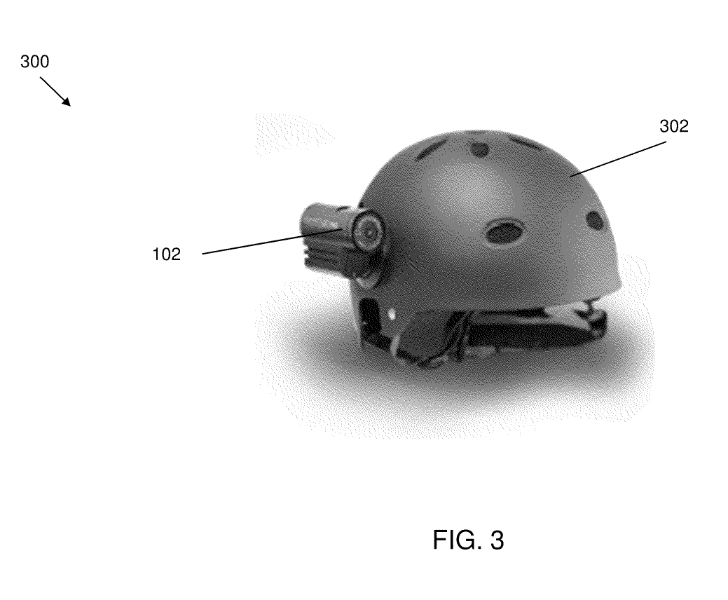

FIG. 3 depicts a portable device 300 including a camera 102, in accordance with still another embodiment of the present invention. The portable device 300 may further include a helmet 302 that may support the camera 102 either fixedly or in a detachable manner.

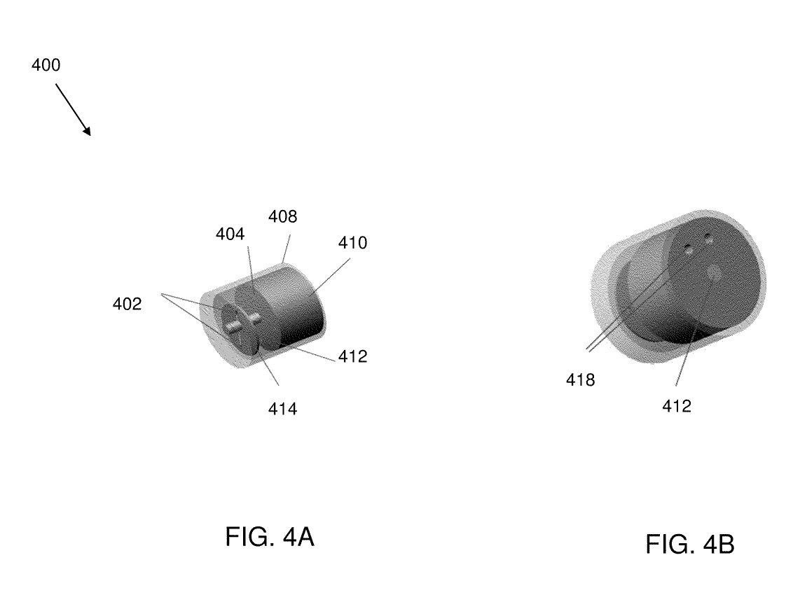

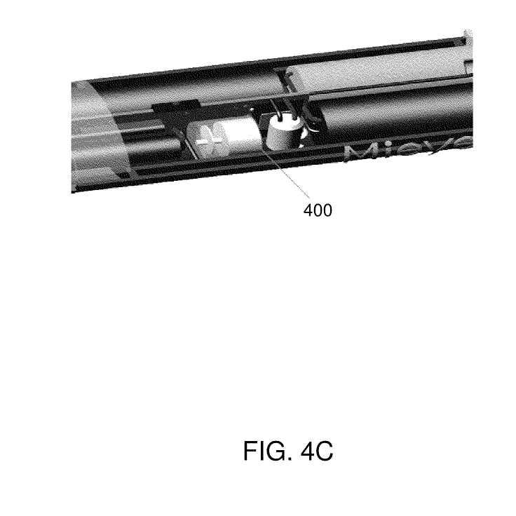

FIG. 4A and FIG. 4B illustrate perspective views of a gimbal balance system 400, in accordance with an embodiment of the present invention. The gimbal balance system 400 may support mounting of the camera 102, in accordance with various embodiments of the present invention. The gimbal balance system 400 may provide several image stabilizing and tracking features to the portable device 100, 200, and 300 such as maintaining a gyro effect, horizon finding, auto leveling, vibration reductions, and the like.

In accordance with a first embodiment, the gimbal balance system 400 may be integrated into the portable device such as the portable device 100. In another embodiment, the gimbal balance system 400 may be provided in a separate housing or enclosure or casing designed for the portable device 100 or the camera 102. The camera 102 may be mounted inside a casing of the gimbal balance system 400 allowing a user to rotate the camera 102. This may further keep the images straight and flat during certain activities such as snowboarding or those involving carving a steep angle on an edge of a body, thereby providing a better perspective angle and making the visuals easy to understand.

In an embodiment, the gimbal balance system 400 may be provided with a lock mechanism. The gimbal balance system 400 may include a body member 402 of the gimbal balance system 400, one or more sensors 404, one or more lasers 408, a laser housing 410, an oscillating disc 412, a shaft 414 mounted on the oscillating disc 412, and data cables 418 to facilitate power transmission to a processing center.

The one or more sensors 402 may be connected to the oscillating disc 412 that may be configured to define an up and down oscillating motion. The one or more lasers 408 may be integrated in a solid body such as the laser housing 410, which may be connected to the body of the camera 102. The body member 402 of the gimbal balance system 400 may be connected to the body of the camera 102. The size of the body member 402 may be reduced by using nano-techniques for accommodating it within a chip.

In accordance with a first embodiment, the shaft 414 may be centrally mounted on the laser housing 410 and off centered with respect to the oscillating disc 412. In accordance with a second embodiment of the present invention, the shaft 414 may be mounted at a central location of the laser housing 410 and the oscillating disc 412. However, the oscillating disc 412 may be made heavier in this case at an outer edge to determine the gravitational pull that may be otherwise determined through the off-centered mounting in accordance with the first embodiment. The oscillating disc 412 may house the one or more sensors 404 that may communicate with the one or more lasers 408.

FIG. 4C illustrates a cross-sectional view of the gimbal balance system 400 assembled in the design of the camera 102, in accordance with the embodiment illustrated in conjunction with FIG. 4A and FIG. 4B of the present invention. The gimbal balance system 400 may be mounted in the camera 102 with the help of the shaft 414 as depicted. In an embodiment, the shaft 414 may be mounted in line with a lens for being used with devices such as a camera or a projector or a combined camera/projector device.

In another embodiment, the gimbal balance system 400 may perform in various other directions such as 45 degrees inclined at a substantially horizontal direction of the shaft to calculate forward and side to side leveling at the same time through software, and the like.

This gimbal balance system 400 may include a second ball inside a first ball with the second ball being heavier at one portion on the outer edge so that it always finds the bottom or gravity. The heavier end of the second ball may have one or more sensors to create a virtual bottom line. In embodiments, the information from the one or more sensors may be read by a laser and accordingly leveling requirements may be identified, and leveling may be done with the help of the software. The software application may then make corrections to the image to be leveled in relation to the camera body or lens or may be maintained at the same position if the gimbal balance system 400 suggests so.

The ball arrangement may also include magnets to hold the balls or rings such as washers, apart with no bearing. This may result in reduced friction between the two balls. In embodiments, the gimbal balance system 400 may be built into a computer chip. In embodiments, the gimbal balance system 400 may be suspended in a fluid within a casing such that heavier object inside the gimbal balance system 400 may find the bottom with the aid of sensors. The sensors may facilitate in determining the position of a device inside the fluid in casing. Further, the gimbal balance system 400 may be shut off and frozen such that the image may stay at this level and any movement would then be seen as normal.

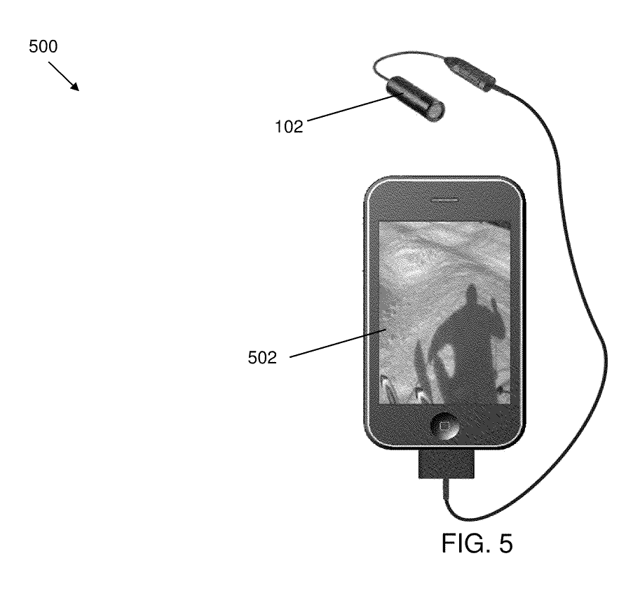

FIG. 5 depicts a networked system 500 referred hereafter to as a system 500 that may connect a plurality of portable devices such as the portable device 100, the portable device 200, and the portable device 300 with a handheld device 502 through a data transmission channel 504, in accordance with the embodiments described in conjunction with FIG. 1, FIG. 2, and FIG. 3.

In an embodiment, the handheld device 502 may be connected with the portable device such as the portable device 100 through a wired mode such as a data transmission cable. The cable may be adapted with connectors suitable for use with various types of handheld devices such as the handheld device 502. It must be appreciated by a person ordinarily skilled in the art that wireless data transmission modes such as using Bluetooth, Infra Red, and the like may also be employed in accordance with alternative embodiments of the present invention without departing from the spirit and scope of the present invention.

The handheld device 502 may be a wireless handheld device in accordance with an embodiment of the present invention such as, but not limited to, a mobile phone like an iphone, a blackberry phone, and the like, a cell phone, a computer, a PDA, a laptop other video cameras, flip video cameras, and the like. The handheld device 502 may include software such as iphone software that may control and manage functioning of the portable device 100. The handheld device 502 may include a broadband wireless media streaming facility that may enable streaming of media such as video, audio or both from a camera 102 such as that configured with any of portable devices 100, 200, or 300, as described herein.

In accordance with the embodiments described in conjunction with FIG. 1, FIG. 2, and FIG. 3, the portable device such as the portable device 100 may provide image stabilizing and tracking features. In an embodiment, the image stabilizing and tracking feature may be provided with the use of the gimbal balance system 400 as described in conjunction with FIG. 4.

The portable device 100 may also include an environmental protection facility to provide environmental protection features including, without limitations, water proofing, shake proofing, fall and drop proofing, weather proofing, and the like. The portable device 100 may further include a positioning feedback facility to provide a feedback for positioning of the camera 102. This may help the user to determine an orientation of the camera 102. The positioning feedback facility may allow the user to orient the camera 102 in a right manner without confirming the orientation by actually viewing a display on the handheld device 502. The feedback positioning features may enable the user to determine an appropriate manner for adjustment of an orientation of the camera 102, an orientation of the field of view of the camera 102, and a measure of the video and audio quality. The feedback provided by the positioning feedback facility may be presented to the user as an audio, video, radiation, light, vibration, and the like and could follow a sensor connected to finger tip for shopping purposes or other. Furthermore, the portable device 100 may also include a vibration damping facility adapted to absorb vibrations and possible forces that may cause damage to the portable device 100 or the camera 102.

In accordance with an embodiment of the present invention, the image stabilizing and tracking facility, environmental protection facility, positioning feedback facility, and the vibration damping facility may be integrated into the portable device 100 or the camera 102.

In accordance with another embodiment of the present invention, the image stabilizing and tracking facility, environmental protection facility, positioning feedback facility, and the vibration damping facility may be provided in a separate housing or enclosure or casing designed for the portable device 100 or the camera 102. In yet another embodiment of the present invention, the image stabilizing and tracking facility, environmental protection facility, positioning feedback facility, and the vibration damping facility may be fitted on a separate facility that may be fixedly or detachably mounted on the portable device 100 or the camera 102.

The portable device 100 may include a portable mounting facility that may be adapted to facilitate mounting of the camera 102 on a table mount, or as a security camera (such as the peephole mount), a web cam for video chat or for home use (e.g., for sports, general purposes, security, connivance, learning, and the like. The portable mounting facility may be intended for a user's wrist, a helmet, a headset, a hat, an eyeglass, a headband, a handlebar, a ski helmet, a sport necklace, a baseball, a skate boarding, a football, a vehicle, a sport bike, X-games, a tie, a belt, a coat, a shirt, a glove, a handle bar, a car dash, a windshield, and the like. In accordance with an embodiment of the present invention, the portable mounting facility may be integrated into the portable device 100 or the camera 102. In accordance with another embodiment of the present invention, the portable mounting facility may be provided in a separate housing or enclosure or casing designed for the portable device 100 or the camera 102.

The portable device 100 may generate a media output that may be experienced at the handheld device 502. In another embodiment, the media output may be experienced at the camera 102.

The camera 102 as described above may include a media capturing facility including an audio capturing facility capable of providing audio capturing features and a video capturing facility capable of providing video capturing features. The audio capturing facility may be a microphone that may be fitted or built into the portable device 100 or the camera 102. In alternative contexts, the audio capturing facility may be integrated into the handheld device 502. Furthermore, the camera 502 may also include a two-way media capturing facility including a two-way audio capturing facility and a two-way video capturing facility such that the user may capture audio and video while simultaneously utilizing the handheld device 502 for other purposes such as listening to phone calls in an embodiment when the handheld device acts as a phone.

In accordance with an embodiment of the present invention, the portable device 100 may generate a plurality of video and video feeds from a plurality of cameras mounted on the portable device 100. The plurality of video and video feeds may be transmitted to the handheld device 502 through one or more data transmitting channels such as the data transmission channel 504 that may be configured to be connected with the handheld device 502 through an input port disposed in the handheld device 502. In accordance with this embodiment, the plurality of video and audio feeds may be streamed separately over a wired or a wireless connection such as through data cables, WiFi, cellular transmission, 3G, 4G, broadband, and the like. In another embodiment, a single camera such as the camera 102 may also include multiple audio and video capturing facilities to generate the plurality of video and audio feeds, such as for interviewing live with split screen visuals. In such a scenario, various parameters of the multiple audio and video capturing facilities such as the field of view, image quality, sound quality, and the like may be adjusted independently.

In embodiments, the camera 102 may capture audio and video information and send and upload it on or through the handheld device 502. The handheld device 502 may act as a storage device configured to store data transmitted from the portable device 100. The handheld device 502 may include a storage medium such as a hard disk, memory card, CD or DVD drive, and the like. The handheld device 502 may also be configured to manipulate, analyze, edit, and perform operations that a normal audio or video camera may do. Thereby, the camera 102 may be reduced to a simple audio and video capturing facility including a lens while the supported operations may be managed by the handheld device 502. In accordance with this scenario, the camera 102 may act as an extension to an already built-in camera that may support software of the handheld device 502, and may require merely a lens separately provided by the camera 102 and a data transmission channel. Thus, the camera 102 may have a simple and compact design. The camera 102 may also include an LED flash. In another embodiment of the present invention, the camera 102 may include software that may connect the camera 102 with the handheld device 502.

In an embodiment of the present invention, the camera 102 may be a handheld camera 102 that may be kept in a hand when required for audio and video capture. The camera 102 may then be kept inside a pocket when the audio and video capturing is not required.

The video captured by the camera 102 and stored on the handheld device 502 may be streamed or uploaded on for example a website, or emailed to a friend. In an embodiment, the software on the camera 102 or the handheld device 502 may automatically link the video to a website and upload it on portals such as www.youtube.com, http://www.ustream.tv, www.Mieye.tv and the like. The website may showcase videos of sports or other forms while users are in actions. For example, a skydiver jumping from an airplane may be able to show his jump and upload it on the website with the use of the camera 102 mounted along him. He may be able to do this before he hits the ground. The website may also provide a platform to connect people such as friends who could form an interface and go online and share media through the use of the website address or just phone numbers. Further, people may also watch someone performing activities live, if they wish. In order to ensure security, a password may be required, based on the preferences of a user of the camera 102.

In embodiments, training sessions, lessons, and classes may be organized through the website where viewers or attendees of the training sessions may ask questions regarding, for example, sport activities. In such cases, the organizers of the training sessions may find related sport experts or other popular persons and mount camera 102 with them and show their live actions to teach the viewers. The schedule of the live actions may be announced on the website in advance.

In embodiments, the portable device 100 may be used by officials such as in police, fire, rescue, and other similar departments by using their own private websites maintained by a central host. Various types of camera designs may be deployed for various kinds of persons. For example, the police may be provided with a gun camera in which the camera 102 may be mounted on the gun such that the police may show shooting actions or various gun loading activities to the viewers, or at police headquarters. In such cases, the camera 102 may be automatically started once the police draw a gun with the use of sensors or other devices such as the gimble balancing system 400. In an embodiment, the police may be linked with headquarters such that the headquarters may be provided with a headset-based camera 102 while the police may be provided with the gun camera. In this case, the police may be guided from the headquarters regarding potential dangers such as through identification of faces of strangers by using face recognition techniques (e.g., through the secure website).

In embodiments, GPS and blueprints may be provided in the headquarters that may assist in guiding the firemen or police to their destinations directly from the headquarters by simply seeing their direction via the camera. For example, the police may be guided (via voice) “turn left into that room”. In addition, the firemen may also be guided and assisted to rescue persons in danger in a burning buildings with the use of blueprints of the buildings. The camera 102 may build communication between two or more persons, operators, and officials with a low cost and through a compact design making it feasible and user friendly system.

In accordance with an embodiment, the Bluetooth camera headset as described in conjunction with FIG. 1 may capture video and audio to show other users about their activities. For example, the camera user may be present in a shopping mart and may connect with his friends or family members through a skype chat or ichat for example to showcase his shopping activities. The other people may watch him on their respective screens and may also guide him during/regarding the purchasing or shopping.

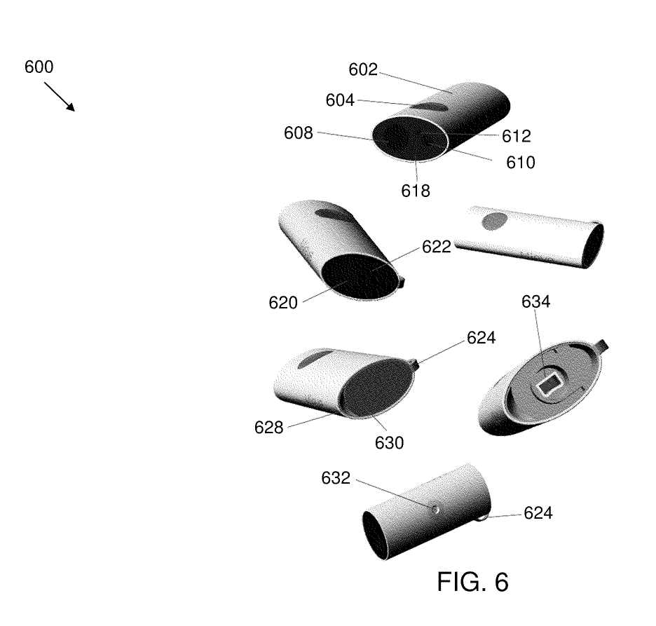

FIG. 6 illustrates various perspective views of physical design of the camera 102 included in a portable device such as the portable device 100, in accordance with various embodiments of the present invention. The camera 102 may include an oval shaped body 602, a power button 604, a video camera lens 608, an LED flashlight 610, and a light sensor 612. In accordance with various embodiments as described later, the portable device 100 may also perform as a projector 614. Therefore, the camera 102 may be integrated with a projector lens 620, a projector screen sensor 622, a leash loop 624, an open spacing 628, a water proof closure 630, a magnetic induction port 632, and a USB data transfer cable 634.

In embodiments, the CPD 102 may include one or more cameras and one or more projectors. Additionally, the one or more cameras and the one or more projectors may share the same lens for video capturing and video projecting. The camera 102 integrated with the projector 612 may hereafter be referred to as the camera-projector device 102 or simply CPD 102 in accordance with certain embodiments of the invention. The terms camera 102 and CPD 102 may therefore be differentiated easily and may merely indicate the two embodiments of a sole camera type or integrated camera-projector type as implemented within the portable device 100.

The oval shaped body 602 may be fabricated as a single piece or a multiple piece body from extruded aluminum or other materials. The oval shaped body 602 may provide a rigid, strong and comfortable shape to the CPD 102. The two ends of the oval shaped body 602 may be capped with glass and/or clear end caps that may be blacked out and may be used for video capturing or projecting moving images. The power button 604 that may act as a video button may be used to operate the CPD 102 such that the operations of the CPD 102 may then be performed by software integrated within the CPD 102 or the portable device 100. The software may be controlled by the user either from the CPD 102 itself or from a remote place with the use of a remote control.

The LED flash or flashlight 610 may be used for motion detection or other similar detection purposes. The LED flash or flashlight 610 may be utilized for image/video capturing. The LED flash 610 may be utilized for photo shooting and the flashlight 610 may be used for video capturing. When the power to the CPD 102 is turned on, the flash or flashlight 610 may change go green for a few seconds and then turn to white light if need is sensed by the light sensor 612. The light sensor 612 may perform in connection with the software to determine the lighting needed during video capture or projection. The point 614 may indicate a location on the oval shaped body 602 where a glass face may be provided for disposing a second projector 618 such that the CPD 102 may be utilized as the projector 614 or camera 102 from both sides of the oval shaped body 602.

The leash loop 624 may be utilized to attach a leash around an object. For example, a wrist to a key chain, or may be utilized to attach a safety leash for mounting the CPD 102 to a mount. Therefore, the leash loop 624 may protect the CPD 102 in case of an accident from loss or damage even if it falls out of the mount for attachment. The open spacing 628 may provide a little space to reach in the open water proof closer 630. The magnetic induction port 632 may be used as a charging port or a docking station mount lock or as a data transfer port such as media transfer port.

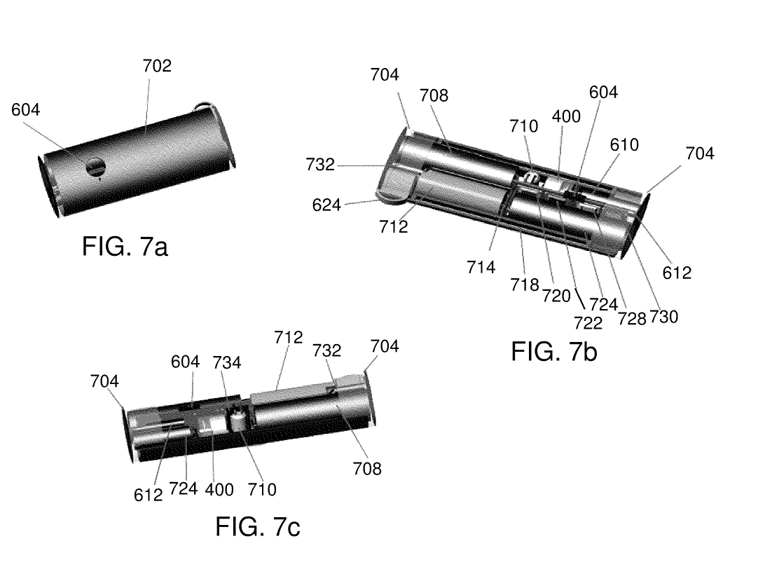

FIG. 7A, FIG. 7B and FIG. 7C illustrate various cross-sectional views of physical design of the CPD 102 included in a portable device such as the portable device 100, in accordance with various embodiments of the present invention. The CPD 102 may include a casing 702 of an inner shell, lens caps 704, a projector lens body 708, a magnetic induction system 710, a gimbal balance system 400, the LED flashlight 610, a built-in battery 712, cables connecting different devices 714, an antenna 718 built into an inner shell locking system (not shown) and sealed for waterproofing, a processor chip 720, a Bluetooth chip 722, a wireless chip 724, a cellular network chip 728, a gimbal processing system chip 730, the light sensor 612, a laser system 732 for a projector screen (not shown) that may a wall or a special screen, and a hard drive 734 to store the media.

The casing 702 of the inner shell may be a two part body with a split section in the middle of the casing 702. The lens caps 704 (also referred as end caps 704) may be sealed to the inner shell and then sealed again to an outer shell for waterproofing purposes at the ends. The power button 604 and the magnetic induction system 710 may be rubberized and sealed to the outer shell. The lens caps 704 may be fabricated from rubber or other similar materials without limitations and provided with a hinge kind of arrangement.

The built-in battery 712 hereafter referred to as battery 712 as indicated in the figure may also be a pull out kind of battery or of any other design. The battery 712 may be powered from the docking station offered by the magnetic induction port 632. In another scenario, the battery 712 may be powered through a wireless based power source such as a WIFI based power source and the like.

The processor chip 720 may process gathered information from the CPD 102 including cameras, projectors, sensors, lasers, gimbal balance systems, power buttons, networks connections, and the like. The cellular network chip 728 may connect directly to an online portal such as a website for streaming and storage of the media. The media thus may be shared with friends such as through ‘Twitter’ to show ongoing activities live or in a real time. The website, in such a scenario, may work only through a licensed chip that may be capable of creating a connection with the website. An exemplary website may be www.mieye.com/streaming that may be used to connect to regular cellular networks with various options of dialing and emergency calling such as with a remote control or a voice command with a microphone. In such a scenario, the user may receive a call even while streaming the media content. The installed software may ask the user regarding his permission to add a concerned person for sharing his media viewing session. If permitted by the user, the concerned added person may also watch the same media content. Therefore, in accordance with this embodiment, any person may just call the user and the user may just click on an accept button to go for sharing the media that the user watches or intends to share.

The hard drive 734 may be used to store media when the CPD 102 may not be able to connect to the network for media storage. An external flash drive may also serve the purpose of the hard drive 734.

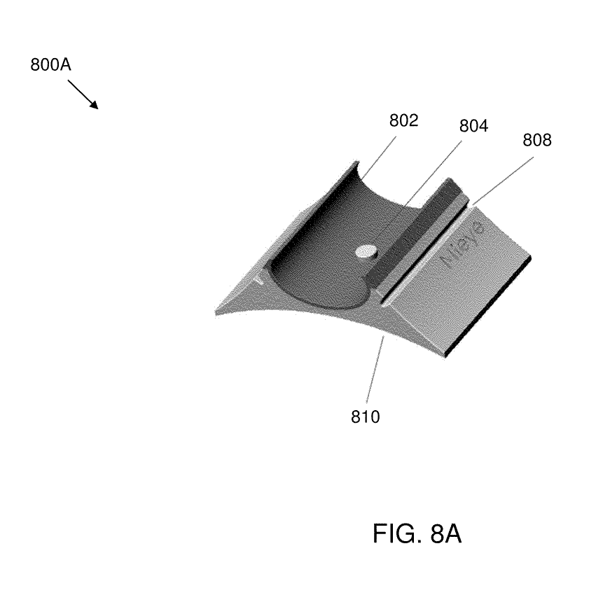

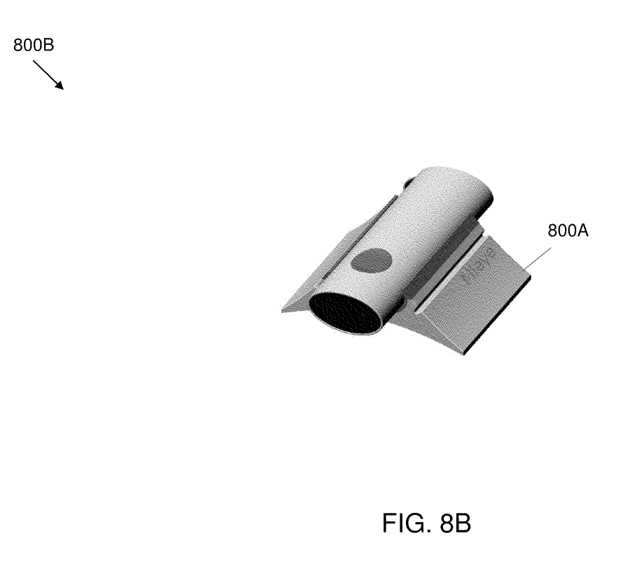

FIG. 8A illustrates a perspective view of a mounting device 800A for mounting the CPD 102 on a helmet such as a helmet 302, in accordance with an embodiment of the present invention. The mounting device 800A may be fabricated from a rubber material, and the like. The mounting device 800A may include a first clip 802 for mounting the CPD 102 on the mounting device 800A, a second clip 804 for holding the CPD 102, a groove 808 for facilitating mounting of the CPD 102, and an attachment mechanism 810 for disposing the mounting device 800A on the helmet 302.

The mounting device 800A may provide a good looking profile by avoiding noises from moving parts during sporting activities. The first clip 802 may be fabricated from a flexible material such as rubber, plastic, and the like. The first clip 802 may be pushed just past half way around the oval shaped body 602 of the CPD 102, as illustrated in FIG. 6. An aperture may be provided on a middle portion of the first clip 802 that may allow a magnetic induction system such as the magnetic induction system 702 to be connected. In addition, the first clip 802 may prevent the CPD 102 to slide out by locking the CPD 102 into the mounting device 800A. In an embodiment, the second clip 804 may be a charging port. In another embodiment, the second clip 802 may be connected through an outside power/data source that may transfer power or data such as video and voice to upload or download such as a through a docking station with streaming built in the docking station or these capabilities built into the camera itself with 3G-4G network

The groove 808 may be a wrinkle provided in the rubber material of the mounting device 800A. The groove 808 may allow the rubber material of the mounting device 800A to conform to the helmet shape. Further, the groove 808 may allow the first clip 802 to move in and out for accepting the CPD 102. In an embodiment, the attachment mechanism may be a hook and loop fastener.

FIG. 8B illustrates a perspective view of the CPD 102 with the mounting device 800A mounted thereon, in accordance with an embodiment of the present invention.

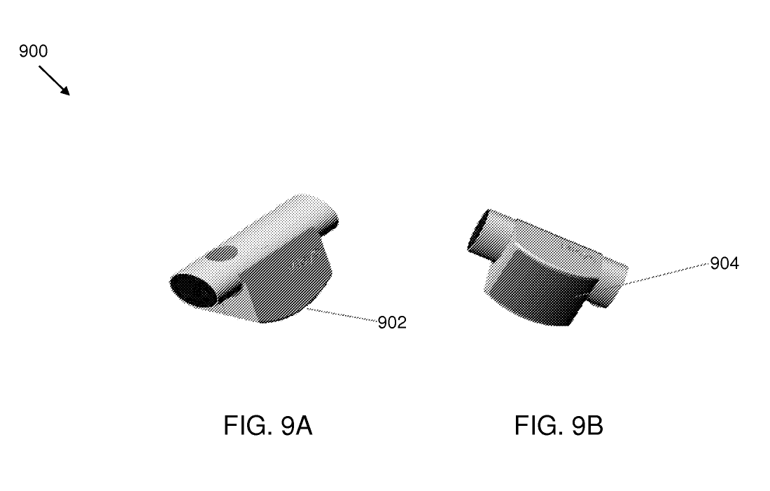

FIGS. 9A and 9B illustrate perspective views of the CPD 102 along with a charging unit 902. The charging unit 902 may include a USB data transfer device capable of being connected with a power source or the magnetic induction system 710 for both power and data transfer. The charge may be provided with a base having a heavy ball or bar (not shown) that may roll along the base of the charging unit 902 to perform as a stabilizer. The ball may stay at the down position and may hold the base at a position that the user may rock it into when rolling of the base is done at a desired angle. The base of the charging unit 902 may be provided with a rubber grip 904 to prevent twisting of the charging unit 902.

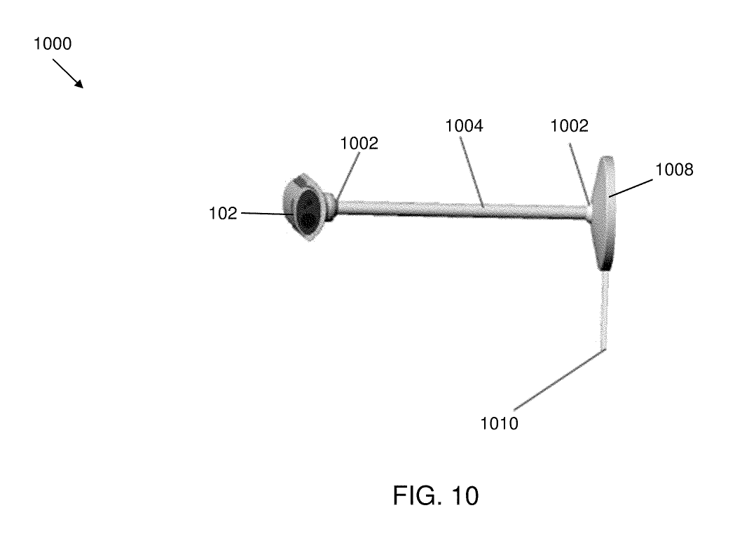

FIG. 10 illustrates a perspective view of a wall mount 1000 to mount the CPD 102 on a wall, in accordance with an embodiment of the present invention. The wall mount 1000 may include a set of ball and socket joint 1002 fitted at either ends of a shaft 1004 joining the CPD 102 with a base plate 1008. In accordance with alternative embodiments, various other coupling or joints may be utilized other than the ball and socket joint 1002. The wall mount 1000 may further include a USB 1010 capable of being connected with a data transmission or power transfer cable.

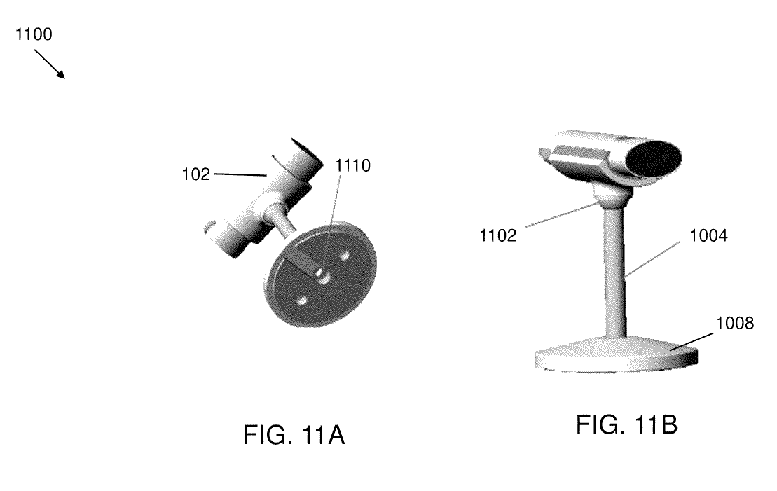

FIG. 11A and FIG. 11B illustrate perspective views of a desk mount 1100 to mount the CPD 102 on a desk or table or shelf and the like, in accordance with an embodiment of the present invention. The desk mount 1100 may include a set of ball and socket joint 1102 fitted at either ends of a shaft 1104 joining the CPD 102 with a base plate 1108. The base 1102 may further include a USB 1100 that may be connected with a data transmission or power transfer cable.

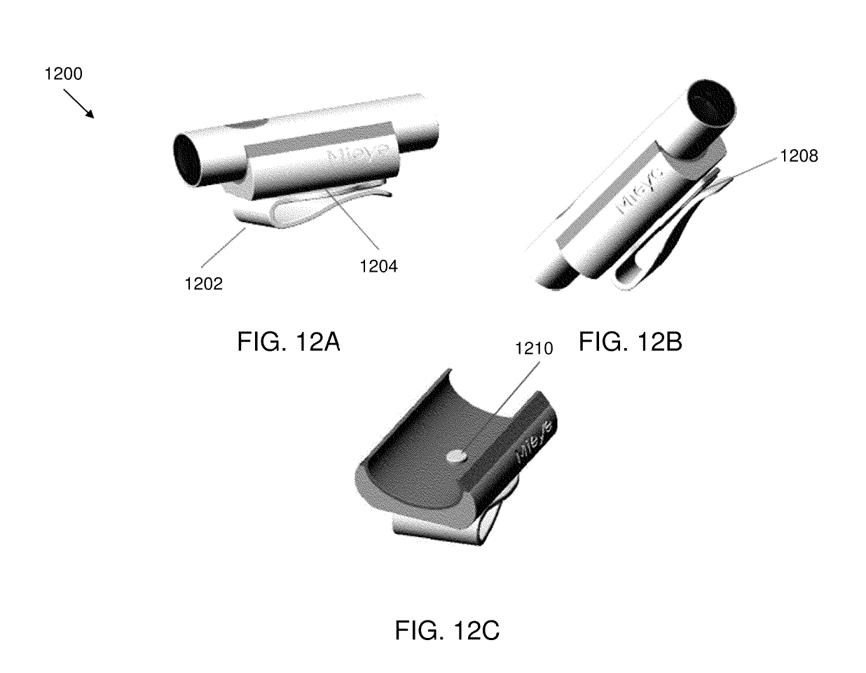

FIG. 12A, FIG. 12B and FIG. 12C illustrate various perspective views of the CPD 102 integrated with a mounting of a clip 1202, in accordance with an embodiment of the present invention. The clip 1202 may be utilized to attach various thin objects such as a base ball cap visor or a car visor, and the like. The clip 1202 may be configured to rotate with the use of a pivot joint 1204 provided on the mounting of the clip 1202. The mounting may further include a rubber pad 1208 to prevent slippage. The mounting may also include a second clip 1210 that may facilitate in preventing sliding of the CPD 102 from the mounting.

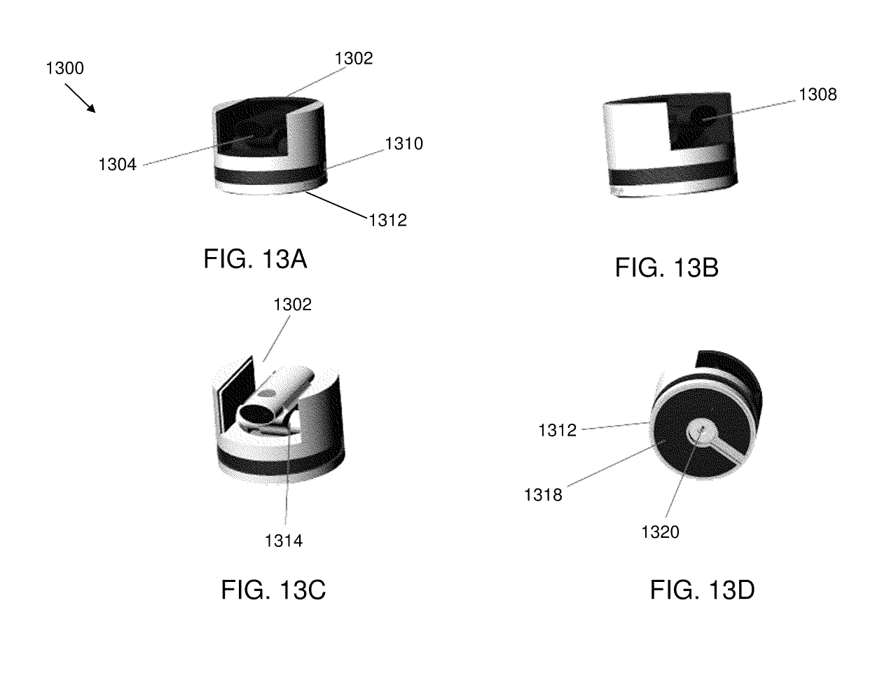

FIG. 13A, FIG. 13B, FIG. 13C and FIG. 13D illustrate various perspective views of a motion detector 1300 for use with the CPD 102, in accordance with various embodiments of the present invention. The motion detector 1300 may include a cover 1302 of the motion detector 1300, a first hollow spacing 1304 to allow a camera to work, a second hollow spacing to allow a projector to work, and a motion sensor unit 1310 that may be configured to rotate at a substantially 360 degree angle around. The motion detector 1300 may further include a cover that may be removed to place the CPD 102 inside the motion detector 1300. FIG. 13C illustrates the placement of the CPD 102 within the motion detector 1300, in accordance with an embodiment of the present invention. The projector and camera of the CPD 102 may work from alternative ends or from the same end of the motion detector 1300.

The motion sensor unit could also be a laser unit interfacing with the projector screen to orientate the picture to the edge of the screen. 1310 may inform the CPD 102 about the location of the action intended to be captured or projected and accordingly may turn housing of the motion detector 1300 in the desired direction around base 1312 of the motion detector 1300. The base 1312 may include a motor and may remain stationary while the housing may rotate through a pulley or a gear trains or other similar kind of mechanical arrangement being actuated through the same or other motor. The motor may adjust the up and down oscillating motion of a shaft 1314 as shown in FIG. 13C.

The base 1312 may be added with a rubber pad 1318 to prevent slippage. Further, the base 1312 may also be provided with a USB data transfer device 1320 capable of being connected with a data and power source or a magnetic induction source for both power and media transfer.

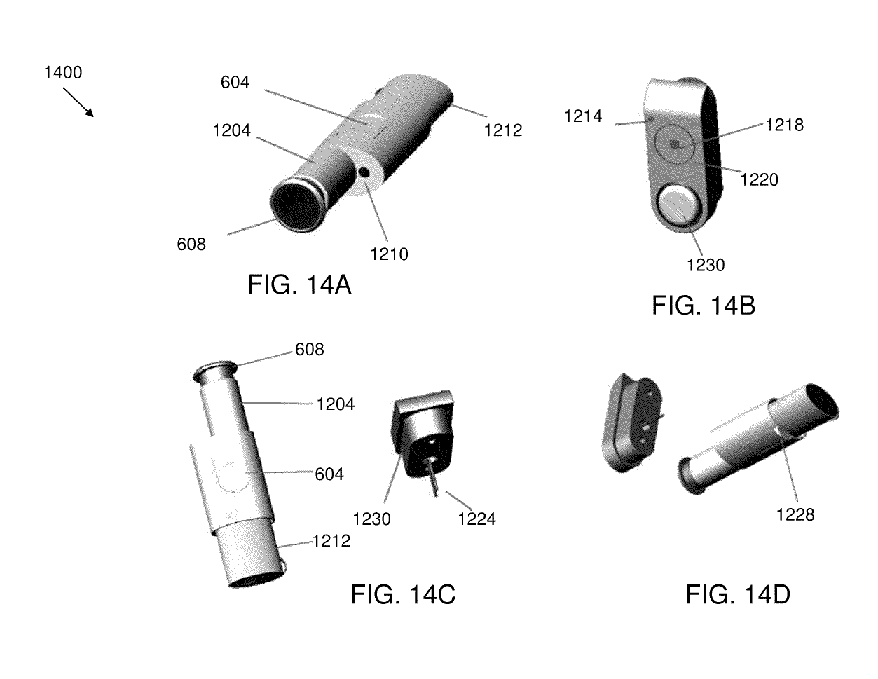

FIG. 14A, FIG. 14B, FIG. 14C, and FIG. 14D illustrate various perspective views of the CPD 102 configured to be fitted in a door, in accordance with an embodiment of the present invention. The housing of the CPD 102 may include a power button 1402 may be fitted within the housing by configuring an aperture through the housing, an extension member 1404 that may enable the CPD 102 to fit through the door, a lens 1408, a screw hole 1410 to secure the CPD 102 to the door, a seat member 1412 for placement of the CPD 102, a motion sensor 1414, a microphone 1418, a speaker 1420, a housing member for wireless network connections 1422, data transfer cables 1424, and locking clips 1428.

The lens 1408 may be affixed in front of the door towards an outside area. The lens 1408 may be manufactured according to the size of an existing peephole in the door, thereby making a quick mount for the CPD 102. The door may also be provided with a screw hole 1410 for securing the CPD 102 to the door. The screw hole 1410 may enable fitting of the lens 1408 of the CPD 102 on the housing.

The motion sensor 1414 may alert an owner about presence of a visitor at the door. In an embodiment, the owner may receive an alert on a phone by activating alerts. In another embodiment of the present invention, the owner may deactivate the alert option. In this embodiment, a door bell 1430 may be used to raise an alert. In another embodiment, the visitor may push a button of the door bell 1430 which in turn may activate the alert by ringing a phone such as a smart phone. For example, when the door bell 1430 is pressed, a call may be made simultaneously on the phone of the owner together with the ringing of the door bell 1430. The owner may pick up the phone to check the alert and interact with the visitor even when he may be seated at a remote place inside the house.

The microphone 1418 may facilitate the owner to talk to the visitor available at the door. The owner may also view a person standing on a front door while being in a backyard for example. In a scenario, the owner may be cooking in a kitchen and may be unable to hear the door bell 1430. The phone, therefore, may start ringing simultaneously to indicate that a visitor is standing at the front door. The owner may converse with the visitor through the microphone 1418. Further, the CPD 102 may include a speaker 1420 to allow the owner to talk with the visitor without disengaging his hands from cooking. Thus, the owner may speak, hear and see the visitor at the same time.

The housing member 1422 may adapt to wireless cellular network connections such as Bluetooth, and the like. The data transfer cables 1424 may be used for powering the CPD 102. The data transfer cables 1428 may also be connected to the door bell 1430. In an embodiment, the door may have a Bluetooth door bell speaker which may be wireless. The locking clips 1428 may facilitate mounting of the CPD 102 to a magnetic induction system such as the magnetic induction system 702, as illustrated in FIG. 7.

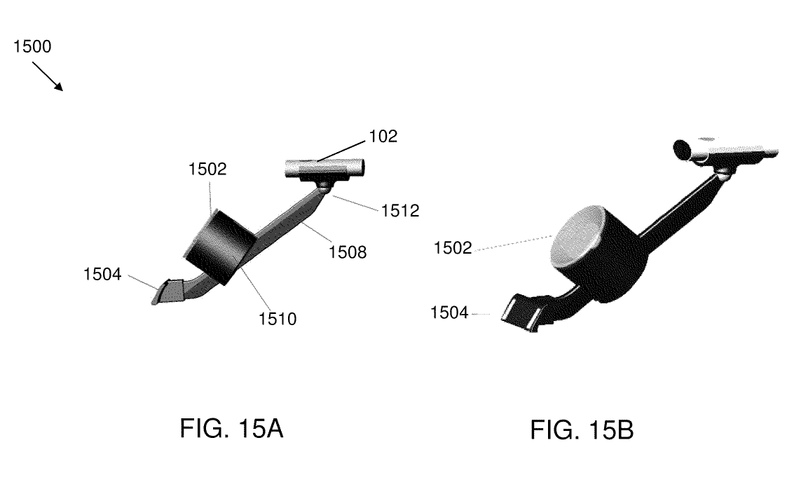

FIG. 15A, and FIG. 15B illustrate perspective views of the CPD 102 configured as a windshield mount 1500 to be used in vehicles, in accordance with an embodiment of the present invention. The windshield mount 1500 may include a suction cup 1502 configured to stick to a windshield, a pressure foot or leverage foot 1504 made from rubber or other similar material capable of sticking to windshield to support laterally, a swing arm 1508, a mount housing 1510 with a pivot point in middle attaching to the swing arm 1508, and a ball and socket joint 1512 pivoting inside a vehicle and attached with the CPD 102.

The swing arm 1508 may be designed longer and heavier on the top portion. This may force the swing arm 1508 into the windshield under the windshield mount 1500 while mounting the windshield mount 1500 substantially angled with respect to the windshield. However, the mounting may also be done in a reverse manner such that the windshield mount 1500 may be mounted on top of the windshield near the rear view minor. In this case the heavy portion of the swing arm 1508 may be kept at the bottom side forcing the pressure foot or leverage foot 1504 into the window above the windshield mount.

The ball and socket joint 1512 may pivot inside a vehicle or may also be positioned at the backside of perons inside the vehicle and attached with the CPD 102. Therefore, video capturing of one's driving from inside the vehicle may be possible.

The weight of the windshield mount 1500 on the windshield may always pull down on the suction cup 1502 resulting in its falling off or slipping down thereby forcing the weight of the windshield mount 1500 straight out from the windshield which may be a better position for securing the CPD 102.

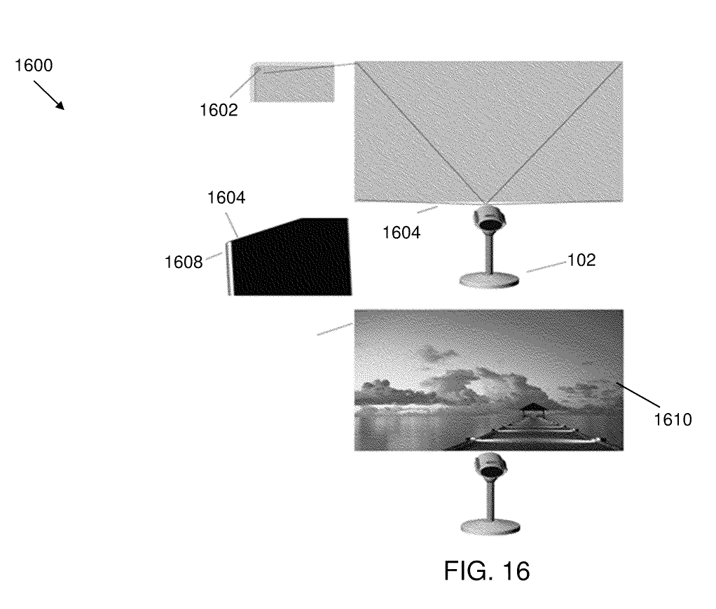

FIG. 16 illustrates a projection functionality of the CPD 102 acting as a projector. In an embodiment, sensors 1602 may be located in four corners of the CPD 102 to communicate with the four corners of the projector screen or tablet and the picture through the software may be aligned to these sensors on the projector screen. The placement and layout of sensors 1602 may vary in accordance with various embodiments. Upon moving the projector screen or tablet around, the picture may automatically follow the movement, and upon movement of the CPD 102 also, the picture may stay straight on the screen. In an embodiment, the projection screen 1604 may be fabricated from glass with anti glare properties. In another embodiment, a glass texture may be applied behind the glass based projection screen 1604. A small depression or a pocket or a groove may be provided behind the projection screen 1604 to facilitate capturing of the images into the projection screen 1604. In addition, the depression or pocket or groove may also assist with outside lighting. The light may easily penetrate through without any difficulty as compared to without the depression or pocket or groove.

FIG. 16 illustrates four lasers projected from the CPD 102 (acting as a projector) and intersecting the projection screen 1604 such that the images may be located on the projection screen 1604 in a perfect manner every time. The image may stay fixed even if the CPD 102 is moved around because of sensors 1604 would provide feedback to facilitate alignment of the image (e.g. laser sensors). Alternative method for determining distance to each of a plurality of corners of the projection on a flat surface may be used to facilitate adjusting the gimble to be properly aligned for viewing. The software may be required to adjust the image display positioning so that the distance is proper to align the four sensors with the four lasers. This may be achieved on a tablet or keyboard with a flat simple face and no buttons. In embodiments, the tablet or the flat surface may include sensors to detect, such as heat detection and the detected information may be sent via wired or wireless connection to the linked device.

A very thin aluminum housing 1608 (may be fabricated from other material) may be provided that may be capable of being mounted to walls or desks or stands and the like. The CPD 102 may just be mounted and held through the aluminum housing 1608 and the sensors 1604 may keep the picture right on the projection screen 1604. An image projected by the CPD 102 on the projection screen 1604 is illustrated in FIG. 16 by 1610.

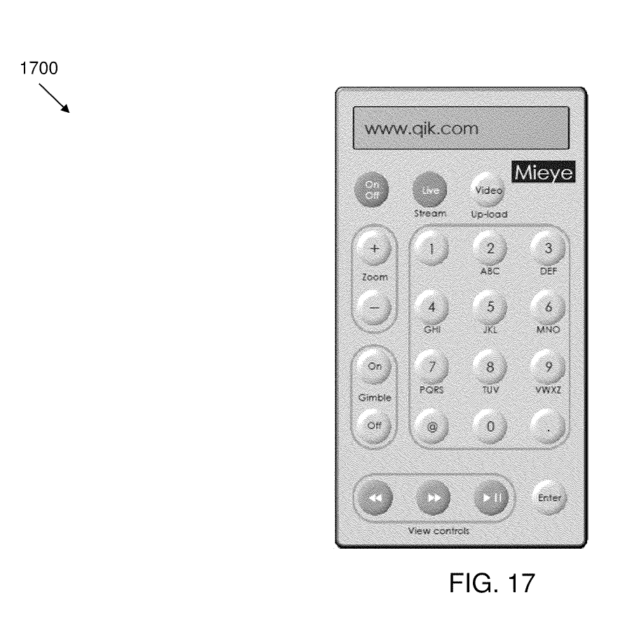

FIG. 17 illustrates a handheld remote controller 1700 for the CPD 102, in accordance with an embodiment of the present invention. The handheld remote controller 1700 may include an on/off button, live streaming and upload button, buttons to enable various functions such as play, fast forward, rewind and the like. In embodiments, the handheld remote controller 1700 may include a transmitter, a transceiver (not shown) and may be adapted to transmit control signals from the handheld remote controller 1700 to the CPD 102 and receive data from the CPD 102. As illustrated, the remote controller 1700 may link the CPD 102 to a web portal which may enable the user to upload live media content on the web portal as well as share live media from a remote location such as from a friend's home and the like. The handheld remote controller 1700 may also be configured to adjust balancing through the gimbal balancing system 400.

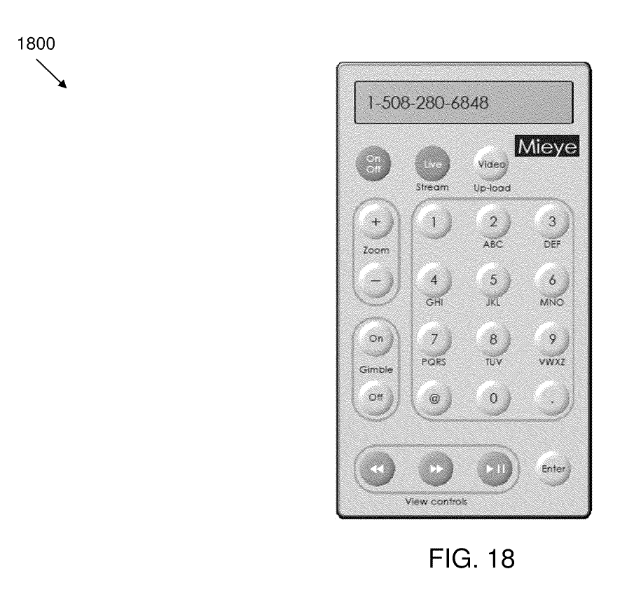

FIG. 18 illustrates a handheld remote controller 1800 for the CPD 102, in accordance with another embodiment of the present invention. As illustrated, the handheld remote controller 1800, in accordance with this embodiment may be linked through a contact number such as a phone number and the like. The functionalities of the handheld remote controller 1700 may also be configured equally within the handheld remote controller 1800.

In embodiments, the CPD 102 may be a multi-purpose pocket video camera and/or projector. The CPD 102 may accomplish all the video needs of a user such as, but not limited to, as a web-camera during a conference call, a helmet camera while kayaking the white water rapid, security cameras, and the like. The CPD 102 may communicate with other devices such as smart phones, microphones, and projector screens using wired or wireless connections. In embodiments, the CPD 102 may be defined primarily as a personal video viewing and video capturing device.

In embodiments, the CPD 102 may communicate with other devices via wireless systems such as but not limited to Bluetooth, WIFI, WIFI-MAX, infrared, cell network, and the like. In embodiments, the CPD 102 may communicate directly with a website with a Network cell chip using any provider and with a remote control-keyboard. Alternatively, the CPD 102 may link automatically to a streaming website such as “Qik.com” preprogrammed or may create a website that may work with its streaming capabilities for a better interaction such as “www.Mieye.com/streaming” where a user may only need to push a button called “stream” as an example.

The CPD 102 may include a camera and a projector that may be built into one pocket device with wireless connectivity, hard drive storage, and gimbal balancing system 400. Additionally, it may be a cross platform camera to use for video conference calls, capture mountain racing, camera streaming live to a website, storing information/pictures to hard drive and view those later with the built in projector or wireless connect to a TV or view on your smart phone, and the like.

In an embodiment, the CPD 102 may be termed as a ‘Dogeez’ camera. The ‘Dogeez’ camera may be connected with a collar of a pet such as a dog through such as a chain with a ball bearing. The ‘Dogeez’ camera may include a GPS, a network cell chip, Bluetooth, and WIFI and the like. The ‘Dogeez’ camera may be mounted to a dog collar or it may be manufactured as a part of the dog collar. The ‘Dogeez’ camera may be linked to a streaming website or any other online portal such as designed for a dog babysitting such as www.dogeez.com portal. A user may, through the online portal, view location of the dog through GPS mapping techniques and tag its spots with information such as a phone number of the person's house where the dog may visit. In another embodiment, distance circles may be set to receive alerts through videos that may get started when the dog goes outside the set circles. Further, the user may also activate a shock into the dog's collar for training purposes. The Dogeez camera may also include a speaker and a microphone and a call button that may be the user's phone number programmed accordingly. A person may press the call button to communicate with the user (owner of the dog) to let him know about the status and condition of the dog. Similarly, the owner may also call the dog and communicate with it and ask it to return.

All documents mentioned herein are hereby incorporated in their entirety by reference.

1. A system for streaming digital media over a network, the system comprising:
a plurality of cameras configured with an image capture facility to capture images;
an image stabilization and alignment facility disposed within at least one of the plurality of cameras; and
a data transmission channel adapted to transmit the digital media including the captured images to a network-enabled handheld device for storage and manipulation.

2. The system of claim 1, wherein the plurality of cameras are mounted on a handset.

3. The system of claim 1, wherein the plurality of cameras are mounted on a helmet.

4. The system of claim 1, wherein the system further comprises a portable mounting facility adapted to mount at least one of the plurality of cameras on one or more of an apparel, a sporting device, a body organ, and a wearable accessory.

5. The system of claim 1, wherein the handheld device comprises a broadband wireless media streaming facility.

6. The system of claim 1, wherein the handheld device comprises one or more of a mobile phone, a cellular phone, a laptop, a Personal Digital Assistant (PDA).

7. The system of claim 1, wherein the data transmission channel comprises a data transmission cable configured to be connected between at least one of the plurality of cameras and the handheld device in a wired mode.

8. The system of claim 1, wherein the data transmission channel comprises a wireless data transmission channel between the plurality of cameras and the handheld device.

9. The system of claim 8, wherein the wireless data transmission channel comprises one or more of a Bluetooth protocol, Infrared protocol, WiFi, 3G, 4G, and broadband communication channel.

10. The system of claim 1, wherein the plurality of cameras comprises an image stability tracking facility.

11. The system of claim 1, wherein the image stabilization and alignment facility comprises a gimbal mechanism for adjustment of image capture orientation.

12. The system of claim 1, wherein the plurality of cameras further comprises an environmental protection facility adapted to protect the plurality of cameras from one or more of weather, water, damage, and shake.

13. The system of claim 1, wherein the plurality of cameras further comprises a positioning feedback facility configured to facilitate determination of one or more of orientation of each of the plurality of cameras, orientation of a field of view of at least one of the plurality of cameras, and image quality.

14. The system of claim 1, wherein the plurality of cameras further comprises a vibration damping facility configured to absorb vibrations.

15. The system of claim 1, wherein the plurality of cameras further comprises a set of media output devices configured to generate output media.

16. The system of claim 15, wherein the media output devices comprises two-way media output devices configured to facilitate listening of the media and capturing of the media.

17. The system of claim 1, wherein the media is automatically streamed to an online platform for sharing.

18. The system of claim 1, wherein the system further comprising a projector configured to project media, the projector being integrated with the at least one of the plurality of camera to perform as a camera projector device.
